(19) United States
(12) Patent Application Publication
(10) Pub. No.: US 2026/0204856 A1
(43) Pub. Date: Jul. 16, 2026

(54) ELECTRICAL AND PHYSICAL SUPPORT WITH ATTACHABLE VEHICLE PLUG

(71) Applicant: Innova Electronics Corporation, Irvine, CA (US)

(72) Inventors: Phuong Pham, Fountain Valley, CA (US); Tuan Le, Ho Chi Minh City (VN); Ninh Do, Ho Chi Minh City (VN); Nha Tran, Tien Giang Province (VN); Thuan Huynh, Ho Chi Minh City (VN)

(21) Appl. No.: 19/017,014

(22) Filed: Jan. 10, 2025

(51) Int. Cl. H01R 33/90

(52) U.S. Cl. CPC H01R 33/90

(57) ABSTRACT

A physical and electrical support device for use in connecting a handheld electronic unit to a port on a vehicle includes a plug configured to be selectively engageable with the port on the vehicle. The plug includes at least one plug electrical contact disposable in electrical connection with the port electrical contact when the plug is engaged with the port. A mounting body is moveably coupled to the plug and is configured to have a first form factor. The mounting body includes a mount electrical contact in electrical communication with the at least one plug electrical contact. A handheld electronic unit is configured to be engageable with the mounting body. The handheld electronic device includes a portion thereof having a second form factor complementary to the first form factor to facilitate engagement between the handheld electronic unit and the mounting body.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a device for supporting a handheld electronic unit within a vehicle, and more specifically to device adapted to interface with an electrical port on a vehicle to facilitate mechanical and electrical support to the handheld electronic unit.

### 2. Description of the Related Art

In today's fast-paced world, our dependence on smartphones and tablets has grown immensely and become an integral part of our daily lives, serving as a primary source of communication, navigation, work, and entertainment. However, the constant use of these devices while on the move can quickly deplete their batteries, leading to inconvenience, frustration, and sometimes even safety concerns. Traditional car chargers, which are often built into the car, have difficulty keeping up with the power-hungry nature of modern smartphones and tablets, as they typically do not support fast charging. As a result, a need for more efficient charging solutions has emerged, prompting the development of fast charging devices designed to work seamlessly through the cigarette lighter port.

The vehicle's cigarette lighter port may serve a dual purpose. One functionality supported by the port may be the supply of electricity to an electrically heated cigarette lighter. Another functionality may include supplying power for portable accessories, drawing directly from the vehicle's electrical system. Most vehicles come equipped with at least one cigarette lighter port, though some models may provide multiple ports, typically catering to front passengers, rear passengers, and the trunk. These power ports typically operate at approximately 12 volts DC.

In 12-volt systems, the positive terminal is typically represented by the center contact, while the negative terminal is typically associated with the circumferential shell or wall. In the majority of automobiles, the negative terminal is connected to the vehicle's frame, establishing a negative ground. The vehicle's 12V power circuit may be safeguarded by a fuse, typically with a rating of 10 to 20 amperes, equating to a power range of 120 to 240 watts.

In addition to meeting the power supply needs of the various electronic units within a vehicle, another issue that commonly arises when operating a vehicle is having an understanding of the operational status of the vehicle. For instance, the driver may benefit monitoring the battery voltage and whether the battery status is good or not to avoid undesirable vehicle malfunction.

Accordingly, there is a need in the art for device that can assist in meeting the power-supply needs of the handheld electronic units within the vehicle, while also providing insight into the operational status of the vehicle. Various aspects of the present disclosure address this particular need, as will be discussed in more detail below.

### BRIEF SUMMARY

In accordance with one embodiment of the present disclosure, there is provided a physical and electrical support device for use in connecting a handheld electronic unit to a port on a vehicle and for providing structural support to the handheld electronic unit via the port, with the port having a port electrical contact. The device includes a plug sized and configured to be insertable within the port and engageable with a port wall to facilitate rigid support of the plug through contact with the port wall. The plug includes at least one plug electrical contact disposable in electrical connection with the port electrical contact when the plug is engaged with the port. A mounting body is moveably coupled to the plug and is configured to have a first form factor. The mounting body includes a mount electrical contact in electrical communication with the at least one plug electrical contact. A handheld electronic unit is configured to be engageable with the mounting body. The handheld electronic device includes a portion thereof having a second form factor complementary to the first form factor to facilitate engagement between the handheld electronic unit and the mounting body.

The plug may be configured to have a variable/adjustable outer diameter to facilitate rigid engagement with the port wall for enabling a desired degree of support through contact with the port wall. The adjustment of the plug outer diameter may enable the plug to conform with a size of the port. The plug may include a telescoping portion configured to facilitate adjustment of the variable outer diameter. The plug may also include a frustoconical surface including the variable outer diameter.

The port may be a DC power port, and the plug may be configured to be insertable into the DC power port to facilitate engagement between the DC power port and the plug.

The plug may be configured to be moveable relative to the mounting body within a prescribed range of motion. The mounting body may include a recess adapted to receive a portion of the plug when the plug is within a portion of the prescribed range of motion. The mounting body may be pivotally connected to the plug.

The first form factor may include a pair of opposed tapered walls.

The handheld electronic unit may be configured to be slidably engageable with the mounting body. The handheld electronic unit may be a vehicle diagnostic dongle configured to communicate with a vehicle electrical system. The handheld electronic unit may be a power bank configured to supply power to a separate electronic unit.

The plug may include a terminal end opposite the mounting body to define a plug length as the distance between the terminal end and the mounting body. The plug may be configured to enable adjustment in the plug length.

The plug and the mounting body may be collectively configured to transfer a load applied by the handheld electronic device to a wall associated with the port.

According to another embodiment, there is provided a support device for use in connecting a handheld electronic unit having an electronic unit form factor to a port on a vehicle, with the port having a port electrical contact. The device includes a plug configured to be selectively engageable with the port on the vehicle. The plug includes at least one plug electrical contact disposable in electrical connection with the port electrical contact when the plug is engaged with the port. A mounting body is moveably coupled to the plug and is configured to have a mounting form factor complementary to the electronic unit form factor to facilitate engagement between the mounting device and the handheld electronic unit. The mounting body includes a mount electrical contact in electrical communication with the at least one plug electrical contact.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a physical and electrical support device taken from a first side, with the device including a handheld electronic unit in the form of a diagnostic dongle;

FIG. 2 is an upper perspective view of the device of FIG. 1 taken from a second side opposite the first side;

FIG. 3 is an upper perspective view of the device taken from a first side, with the device including a handheld electronic unit in the form of a power bank;

FIG. 4 is an upper perspective view of the device of FIG. 3, taken from a second side opposite the first side, the power bank being detached from a mounting body;

FIG. 5 is an upper perspective view of the device of FIG. 1, with the diagnostic dongle mounted on a mounting body;

FIG. 6 is a lower perspective view of the device of FIG. 1, with the diagnostic dongle being detached from the mounting body;

FIG. 7 is a partial, front view of an engagement portion of the plug having a plurality of telescoping segments, the engagement portion being depicted in an extended position;

FIG. 8 is a partial, cross sectional view of the engagement portion of FIG. 7, with the engagement portion being depicted in a nested/collapsed position;

FIG. 9 is a system level overview depicting an exemplary use of the device;

FIG. 10 is a front view of the power bank of FIG. 3;

FIG. 11 is a lower perspective view of an embodiment of the device of FIG. 3, the power bank being depicted in a partially engaged configuration with the mounting body;

FIG. 12 is a lower perspective view of the device of FIG. 11;

FIG. 13 is an upper perspective view of the device of FIGS. 11 and 12;

FIG. 14 is a lower perspective view of the device of FIG. 3, with the plug in a stowed configuration relative to the mounting body;

FIG. 15 is a perspective view of the device of FIG. 3 engaged with a port on a vehicle;

FIG. 16 is a perspective view of the device of FIG. 3, with the plug engaged with the port on the vehicle and the power bank separated from the mounting body;

FIG. 17 is an upper perspective view of an embodiment of the device of FIG. 1, the device having a telescoping plug adapted to enable selective length adjustment thereof;

FIG. 18 is an upper perspective view of an embodiment of the device of FIG. 1, the device having a shape-configurable plug to enable selective configurability of the plug; and

FIG. 19 is a side view of another embodiment of the device having a pivoting extension arm coupled to the plug and extending between the plug and the handheld electronic unit.

Common reference numerals are used throughout the drawings and the detailed description to indicate the same elements.

### DETAILED DESCRIPTION

The detailed description set forth below in connection with the appended drawings is intended as a description of certain embodiments of an electronic device charger and physical support and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a device adapted to leverage the structure and functionality of an auxiliary power port on a vehicle (e.g., a cigarette lighter port) to supply power and provide physical support to a handheld electronic unit (HEU), such as a vehicle diagnostic dongle or a power bank. The device may provide fast charging to the HEU, while also positioning the HEU in an easy to view position and orientation to enable a driver to quickly and easily view content on the HEU, such as power levels, etc.

Referring now to the drawings, wherein the showings are for purposes of illustrating preferred embodiments of the present disclosure, and are not for purposes of limiting the same, there is depicted a physical and electrical support device 10 generally comprised of a plug 12, a mounting body 14, and a HEU 16. The plug 12 is configured to be selectively engageable with port 18 (see FIGS. 15 and 16) on the vehicle. It is common for the port 18 to include a generally cylindrical shape that is of a prescribed diameter and depth. The size and shape of the plug 12 may be complementary to that of the port 18. In this regard, the plug 12 may have a cylindrical shape having a diameter that is slightly less than that of the port 18 to enable insertion of the plug 12 into the port. The diameter of the plug 12 may also be configured such that the plug 12 may be snuggly fit (e.g., a friction fit) within the port 18 when inserted therein to facilitate the transfer of forces from the plug 12 to the port 18. In this regard, the port 18 may support the entire weight of the device 10 when the plug 12 is inserted in the port 18. As such, there may be contact between an outer wall of the plug 12 and an inner wall of the port 18 to enable transfer of such forces.

The plug 12 may also include at least one electrical contact that may be disposable in electrical communication with an electrical contact on the port 18. In the exemplary embodiment, the plug 12 includes a terminal electrical contact 20 and a pair of lateral electrical contacts 22. The terminal electrical contact 20 may be a positive terminal, while the pair of lateral electrical contacts 22 may be negative terminals. The contacts 20, 22 may be spring biased toward the surface of the port 18 when the plug 12 is inserted into the port 18. The spring biasing force may also help to support the device 10 when inserted in the port 18, by increasing the friction between the plug 12 and the port 18.

It is contemplated that the port 18 on the vehicle may vary, such that some ports 18 have a different diameter than other ports 18. Therefore, various aspects of the present disclosure relate to features of the plug 12 that may enable adjustment to conform to the size of a particular port 18. In this regard, the plug 12 may be configured to enable selective adjustment in an operative outer diameter of the plug 12. In this regard, the term operative outer diameter refers to that portion of the plug 12 that may be engageable with the vehicle port 18. In one embodiment, the plug 12 may include a telescoping engagement portion 15 configured to facilitate adjustment of the variable outer diameter. The telescoping engagement portion 15 may be configured such that the operative outer diameter of the telescoping engagement portion 15 may be decreased by extending the telescoping engagement portion 15 to expose telescoping segments 17 having smaller diameters. FIG. 7 shows the engagement portion 15 in an extended configuration, with all depicted telescoping segments 17 being exposed. As can be seen, each telescoping segment 17 has a different sized outer diameter relative to the adjacent telescoping segment 17. From the perspective depicted in FIG. 7, the lowest telescoping segment 17 has an outer diameter less than that of the telescoping segment 17 immediately above it. As you keep moving upward, the operative diameter of the telescoping segments 17 increases. Conversely, the operative outer diameter of the telescoping engagement portion may be increased by collapsing/decreasing the telescoping engagement portion 15 to nest telescoping segments 17 having a smaller diameter within telescoping segments 17 having a larger diameter. FIG. 8 shows the engagement portion 15 in a collapsed/nested configuration. Thus, by selectively exposing the telescoping segments 17 or nesting the telescoping segments relative to each other, the effective outer diameter of the engagement portion 15 may be increased or decreased. Each telescoping segment 17 may include lateral electrical contacts 22, while the inner most (e.g., smallest) telescoping segment 17 may include a terminal electrical contact 20.

In another embodiment, the engagement portion of the plug 12 may include a frustoconical surface including the variable outer diameter. In this regard, the outer diameter of the frustoconical outer surface may vary from one end of the engagement portion to another. A narrow end of the engagement portion may be inserted into the port 18 and an upper rim or upper portion of the port wall may engage with the segment of the frustoconical portion having a similar outer diameter. In this respect, the segment of the frustoconical portion having an outer diameter less than that of the port 18 may reside in the port 18, while the segment of the frustoconical portion having an outer diameter greater than the port 18 may extend outside of the port 18. The operative diameter of the plug 12 may be varied by varying the amount of the plug 12 inserted into the port 18. By inserting a greater segment of the plug 12, the operative diameter may be increased. Conversely, by only inserting a smaller segment of the plug 12, the operative diameter may be decreased. The narrower segment may be weighted to make tipping of the plug 12 out of the port 18 less likely.

It is contemplated that other modalities of adjustment of the operative outer diameter may also be employed without departing from the spirit and scope of the present disclosure. For instance, the plug 12 may be configured for selective use with a set of size adjusting attachments, wherein the plug 12 is of a minimal effective outer diameter, and the size adjusting attachments are configured to be attached to the plug 12 to increase the operative outer diameter thereof. Thus, by changing the attachment to which the plug 12 is connected, or removing the attachments altogether, one may change the effective outer diameter of the plug.

It is also contemplated that the a distal end portion of the plug 12 (e.g., the end portion of the plug inserted into the port 18) may include a spring loaded gripper that can be extended outwardly to engage with the port wall after the plug has been inserted into the port 18 to enhance the overall rigidity and structural stability of the plug 12 within the port 18. The gripper may include a pair of gripping bodies that extend in opposed directions to enhance the friction between the plug and the port wall. The gripping bodies may be actuated by a button or other actuator, which when pressed or actuated, deploys the gripping bodies from a main portion of the plug. The gripping bodies may be retracted to facilitate removal of the plug 12 from the port 18.

The mounting body 14 is moveably coupled to the plug 12 and is adapted to facilitate selective engagement with the HEU 16. In one embodiment, the mounting body 14 is pivotally coupled to the plug 12 to enable pivotal movement of the mounting body 14 relative to the plug 12 about a pivot axis 24 by an amount Θ. The pivotal movement may enable selective angular positioning of the HEU 16 when the HEU 16 is connected to the mounting body 14. The mounting body 14 may be configured to pivot up to 180 degrees relative to the plug 12 to accommodate the various positions of the port 18 on the vehicle. Along these lines, it is understood that the port 18 may extend along a vertical direction, or alternatively, extend along a horizontal direction, or in another alternative, extend at an angle between the vertical and the horizontal. As such, by enabling pivotal movement of 180 degrees, the user may easily adjust the HEU 16 on the mounting body 14 into a desired position.

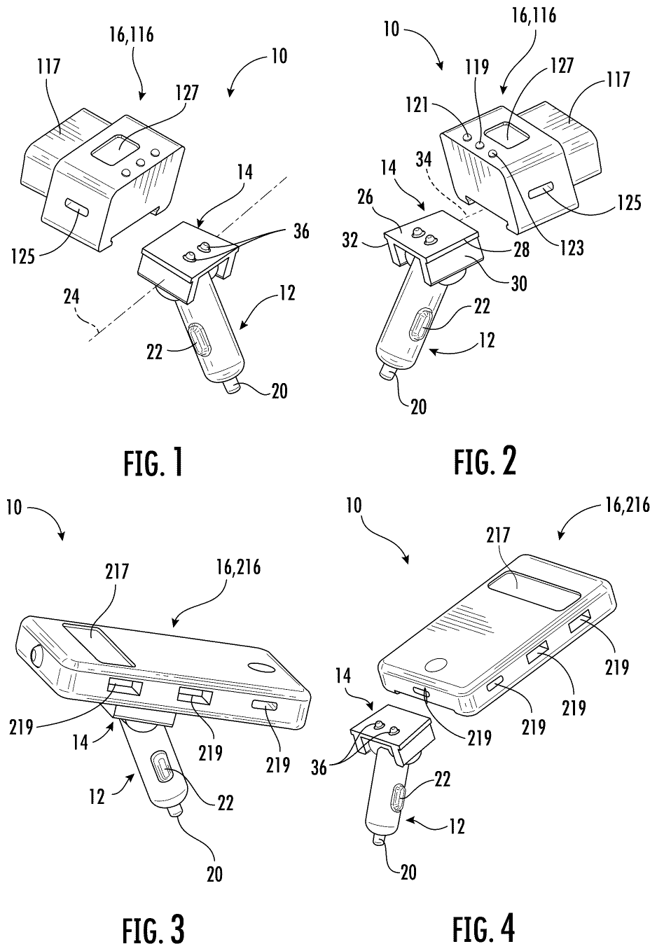

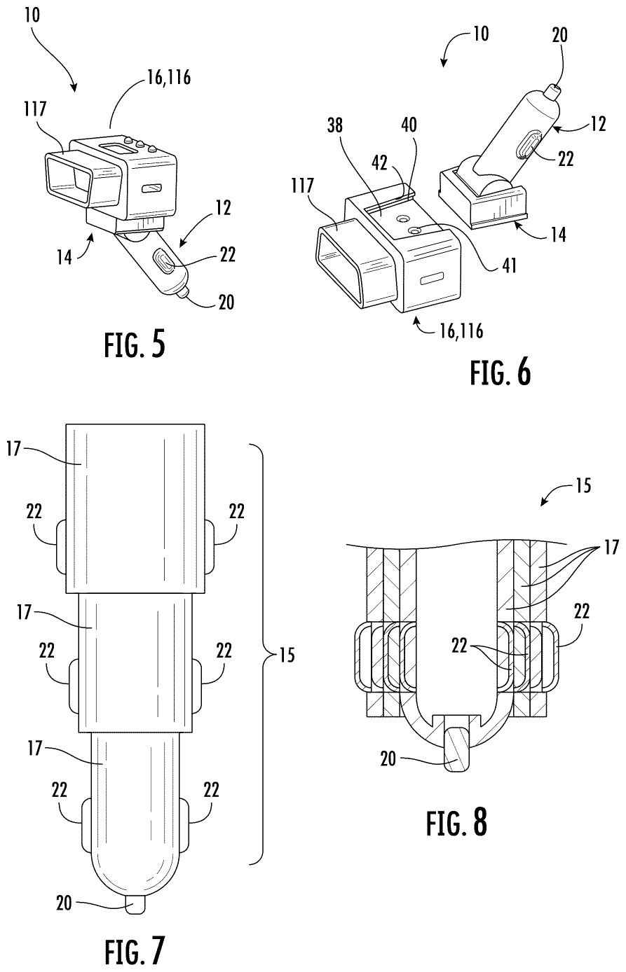

The mounting body 14 may have a first form factor that is complementary to a second form factor on the HEU 16. In the embodiment depicted in FIGS. 1-6, the first form factor is defined by an upper surface 26, a pair of outer side surfaces 28, a pair of inward side surfaces 30, and a pair of under surfaces 32. The upper surface 26 may be a generally planar surface extending between the pair of outer side surfaces 28. The outer side surfaces 28 may extend between the upper surface 26 and the pair of under surfaces 32, which extend to the pair of inward side surfaces 30. The inward side surfaces 30 may be positioned closer to a central axis 34 than the pair of outer side surfaces 28. In one embodiment, the pair of outer side surfaces 28 may be generally parallel to each other, while in other embodiments the pair of outer side surfaces may be generally tapered relative to each other. The tapered configuration may facilitate engagement between the mounting body 14 and the HEU 16 in a prescribed orientation.

The mounting body 14 may include one or more mount electrical contacts 36 in electrical communication with the electrical contacts 20, 22 on the plug. In this regard, internal wiring may extend between the mount electrical contacts 36 and the plug electrical contact 20, 22.

The mounting body 14 may include an internal magnet, which may be helpful in facilitating connection with various electronic devices, other than the HEU 16, such as a smartphone. In this regard, while the cooperating form factors may be used to facilitate connection between the mounting body 14 and the HEU 16, as explained in more detail below, the magnet in the mounting body may be useful to enable the mounting body 14 to connect with devices other than the HEU 16. However, the magnet may supplement the operative connection between the mounting body 14 and the HEU 16.

The mounting body 14 may also include internal circuitry needed to configure electrical communications between the vehicle and the HEU 16. Along these lines, the mounting body 14 may include a voltage convert circuit that may convert a 12V signal to a 5V signal.

The HEU 16 is connectable to the mounting body 14 to locate the HEU 16 in a position that is easy for interaction by a driver or passenger in the vehicle. As will be explained in more detail below, the HEU 16 may include multiple devices (e.g., diagnostic dongle 116, power bank 216, etc.); however, each HEU 16 may include a form factor designed to slidably engage with the form factor of the mounting body 14. In this regard, the HEU form factor may include a generally planar mounting surface 38, a pair of side surfaces 40 and a pair of retaining surfaces 42 extending toward each other from the pair of side surfaces 40. The surfaces 38, 40, 42 collectively define a recess on the HEU 16 which is sized to receive a portion of the mounting body 14. When the HEU 16 is engaged with the mounting body 14, the generally planar mounting surface 38 is positioned adjacent the upper surface 26 of the mounting body 14, the pair of side surfaces 40 are positioned adjacent the pair of outer side surfaces 28, and the pair of retaining surfaces 42 are positioned adjacent the under surfaces 32. This complementary, cooperative configuration and engagement allows the HEU 16 to be securely mounted to the mounting body 14.

The HEU 16 may include one or more electrical contacts 41 that are disposable in electrical communication with the electrical contacts 36 on the mounting body 14 when the HEU 16 is engaged to the mounting body 14. As such, the HEU 16 may be disposable in electrical communication with the vehicle through the electrical contacts 20, 22, 36 and 41.

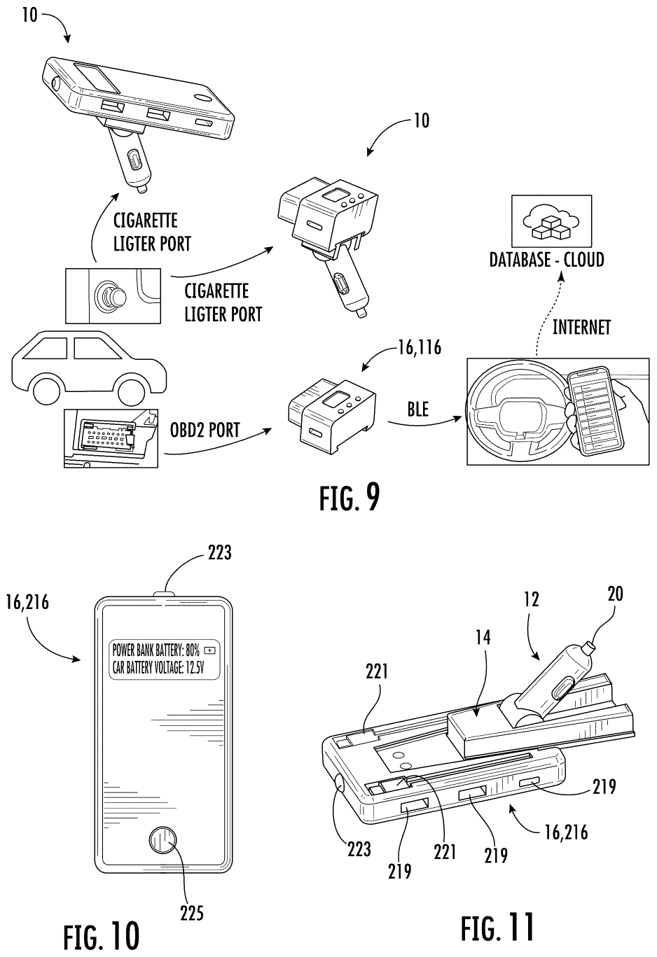

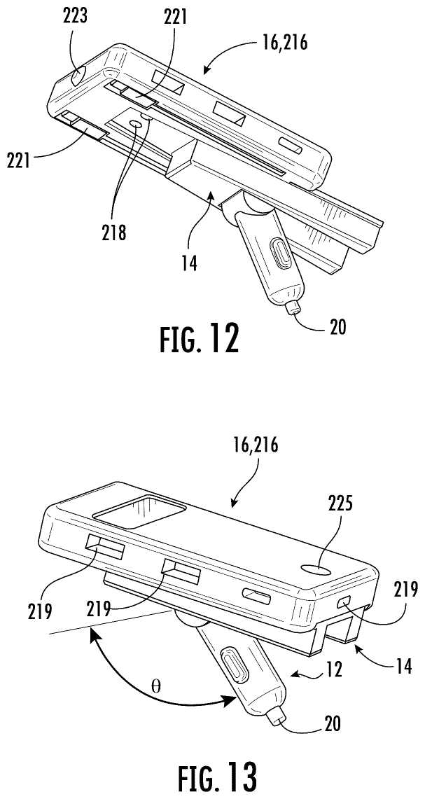

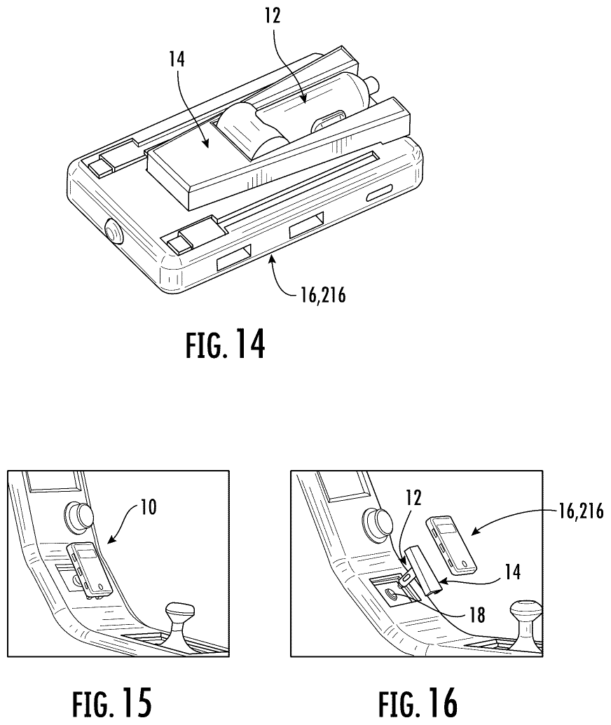

One example of the HEU 16 is dongle 116 adapted to interface with a vehicle diagnostic port on the vehicle (e.g., an OBD2 port) when removed from the mounting body 14. In more detail, the dongle 116 may include a diagnostic connector 117 sized and configured to be connectable to the diagnostic port to facilitate communication with one or more electrical devices, systems, or components on the vehicle. The dongle 116 may be compatible with the mobile app via BLUETOOTH or other known wireless communication modalities, to offer a wealth of vehicle diagnostic features, as shown in FIG. 9. For instance, the dongle 116 may be capable of conducting OBD2 smog checks, displaying vital vehicle parameters (e.g., RPM, speed, brake life, oil levels, fuel levels, etc.), read codes, erase codes from all modules, and provide insights into the vehicle's oil level, oil life, brake pad life, tire pressure, and more. In many ways, the information provided by the dongle 116 may be like having a technician at your fingertips, helping to make informed decisions about the vehicle's maintenance.

To operate the dongle 116, the user may turn the key ON without starting the engine, and then open the mobile app on the smartphone or tablet, and scan for the dongle device and connects to the mobile app via BLUETOOTH. After successful connection, users can perform the functions noted above. The dongle 116 may be configured for plug-and-play operation, such that the dongle 116 may initiate communications with the vehicle electrical systems in response to physical connection with the diagnostic port. Thus, no additional input may be required by the user. For more information regarding the retrieval and use of data from the vehicle using the dongle, please refer to the following U. S patents and published patent applications, owned by Innova Electronic Corporation, which is also the owner of the present disclosure: U.S. Pat. No. 6,807,469, entitled AUTO DIAGNOSTIC METHOD AND DEVICE, U.S. Pat. No. 6,925,368, entitled AUTO DIAGNOSTIC METHOD AND DEVICE, U.S. Pat. No. 7,620,484, entitled AUTOMOTIVE MOBILE DIAGNOSTICS, U.S. Pat. No. 8,019,503, entitled AUTOMOTIVE DIAGNOSTIC AND REMEDIAL PROCESS, U.S. Pat. No. 8,370,018, entitled AUTOMOTIVE DIAGNOSTIC PROCESS, U.S. Pat. No. 8,909,416, entitled HANDHELD SCAN TOOL WITH FIED SOLUTION CAPABILITY, U.S. Pat. No. 9,026,400, entitled DIAGNOSTIC PROCESS FOR HOME ELECTRONIC DEVICES, U.S. Pat. No. 9,177,428, entitled PREDICTIVE DIAGNOSTIC METHOD, U.S. Pat. No. 9,646,432, entitled HAND HELD DATA RETRIEVAL DEVICE WITH FIXED SOLUTION CAPABILITY, U.S. Pat. No. 10,643,403, entitled PREDICTIVE DIAGNOSTIC METHOD AND SYSTEM, U.S. Pat. No. 11,068,560, entitled METHOD OF PROCESSING VEHICLE DIAGNOSTIC DATA, U.S. Pat. No. 11,270,529, entitled SYSTEM AND METHOD FOR PROACTIVE VEHICLE DIAGNOSIS AND OPERATIONAL ALERT, U.S. patent application Pub. Ser. No. 11/158,141, entitled SYSTEM AND METHOD FOR PROACTIVE VEHICLE DIAGNOSIS AND OPERATIONAL ALERT, U.S. patent application Ser. No. 12/112,587 entitled SYSTEM AND METHOD FOR GUIDED VEHICLE DIAGNOSTICS, and U.S. patent application Ser. No. 11/915,534 entitled VEHICLE DIAGNOSTICS WITH INTELLIGENT COMMUNICATION INTERFACE, the entire contents of each of which is expressly incorporated herein by reference.

When not plugged into the diagnostic port, the dongle 116 may easily slide onto the mounting body 14 to stow the dongle 116, and to connect the dongle 116 to a power signal from the vehicle, while also positioning the dongle for easy access to the occupants of the vehicle. In this regard, the dongle 116 may provide certain vehicle information to the user, while also serving as a charging hub for other electronic devices while mounted on the mounting body 14. The dongle 116 may monitor the vehicle battery when mounted to mounting body 14 via analysis of the power signal received by the dongle 116. When the battery voltage is below an allowed threshold, a yellow LED 119 may flash continuously to warn the driver about the condition of the vehicle battery. The dongle 116 may be capable of monitoring the starting system to determine battery status when starting the engine and provide a warning to the driver by flashing a red LED 121 continuously when the dongle detects that the battery is about to fail. The dongle 116 may also include a green LED 123 which may be illuminated when ideal battery parameters are detected. Information regarding the battery voltage may also be depicted in a display screen 127 integrated into the dongle 116. The dongle 116 may also include a speaker to generate an audible alert in addition to the visual alerts noted above. The audible alert may include verbal alerts (e.g., “battery level low”) or beeps indicative of various battery health conditions.

The dongle 116 may also be configured to facilitate fast charging for smartphones and tablets when the dongle 116 is connected to the mounting body 14. The dongle 116 may have one or more USB-C fast-charging ports 125 on opposite sides of the dongle 116 to cater to both the driver and the passenger. Thus, the various electronic devices used by the occupants of the vehicle (e.g., smartphones, smart watches, tablets, headphones, etc.) may be charged simultaneously and rapidly, which may be particularly useful for long journeys, daily commutes, and tech-savvy travelers.

In certain embodiments, the dongle 116 may include a rechargeable battery that may allow the dongle to function as a power supply when not connected to the mounting body 14. In this regard, a user may take the dongle 116 out of the vehicle to provide backup power to a smartphone or other electronic device. This may be useful when the user's electronic device is low on power, and the user may not have access to other power supplies. For instance, if the user arrives at a mall for shopping, the user can plug their phone into the dongle to receive power while the user is shopping. The dongle 116 may be small enough to stow in purse or backpack with the electronic device during charging.

As noted above, the HEU 16 is not limited to a diagnostic dongle 116, and may also include a portable power bank 216 configured to charge smartphones, tablets, and other devices. The portable power bank 216 is configured to connect with the mounting body 14 to charge the battery of the power bank 216 via electrical contacts 218. The portable power bank 216 may include an LCD 217 to display the vehicle's battery voltage, the capacity of the power bank, and any charging-related icon(s). The portable power bank 216 includes USB ports 219 to charge phones and tablets on both driver side and passenger side. The power bank 216 may additionally include USB wires 221 that can connect directly to the phone/tablet. The USB wires 221 may be stowable within respective recesses formed in the power bank 216, and preferably on an underside of the power bank 216. The portable power bank 216 may also include a flashlight 223 that can be turned on by pressing and holding a power button 225. In one particular implementation, the portable power bank 216 includes a lithium battery 5000 mAh, 4 USB-A ports, 2 USB-C ports, and 1 USB-C charge.

The portable power bank 216 includes a form factor adapted to engage with the form factor of the mounting body 14, as described in more detail above. In this regard, the portable power bank 216 includes a recess adapted to receive a portion of the mounting body 14.

It is contemplated that the same mounting body 14 may be configured for use with both the dongle 116 and the power bank 216. In this regard, when the dongle 116 is plugged into the diagnostic port on the vehicle, the power bank 216 may be connected to the mounting body 14 to recharge the power bank and to provide information regarding the vehicle's battery. Furthermore, when the power bank 216 is removed from the mounting body 14, the dongle 116 may be engaged therewith to for recharging of the dongle 116, and to provide information regarding the vehicle's battery. Thus, the user may interchange the HEU's 16 as may be desired.

Although the examples described above include an HEU 16 having a recess configured to slidably receive a portion of the mounting body 14, it is contemplated that the configuration may be reversed. Namely, the mounting body 14 may include a recess configured to slidably receive a portion of the HEU 16.

Referring now to FIGS. 15 and 16, it is contemplated that various embodiments of the plug 12 may be specifically configured to enable selective length adjustment, and/or selective length configuration to accommodate the various positions of the port 18 in the vehicle, as well as to navigate through or around obstacles within the vehicle. For instance, the port 18 may be located deep within a center console or glove box, and the plug 12 may extendable and/or length configurable to extend and curve through the console or glove box to a position that is more readily viewable or accessible by the user.

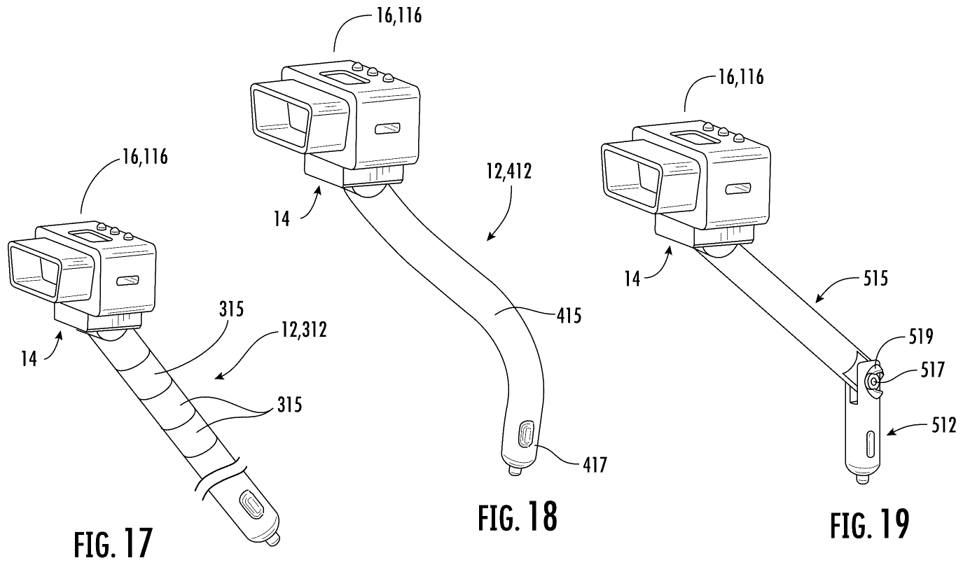

FIG. 17 depicts plug 312 that is telescopic and includes a plurality of separate plug components 315, each being moveable relative to adjacent plug components 315. Each plug component 315 may be moveable between an overlapping/collapsed position and an extended position, with the degree of overlap between the plug component 315 and the adjacent plug component 315 decreasing as the plug component 315 moves from the overlapping position toward the extended position. Conversely, the degree of overlap between the plug component 315 and the adjacent component increases as the plug component 315 moves from the extended position toward the overlapping position. When all of the plug components 315 are in their respective extended positions, the length of the plug 312 is at a maximum, and when all of the plug components 315 are in their respective overlapping positions, the length of the plug 312 is at a minimum. The plug components 315 may have some measure of lateral movement relative to the adjacent plug components 315, such that the plug length may be fixed due to the weight of the mounting body 14 and HEU 16 on the plug 312. In this regard, the weight may result in the collective plug components 315 assuming a slightly arcuate configuration, which may hold the plug 312 in the particular length. To adjust the length, the user may simply pull or push on the mounting body 14 or HEU 16 (when connected to the mounting body 14), to either increase or decrease the plug length.

In FIG. 18, plug 412 depicted, with plug 412 being adapted to assume a variety of different shapes to extend through and/or around obstacles in the vehicle. This embodiment of the plug 412 may be similar to a gooseneck microphone cable or a gooseneck lighting cable that is selectively flexible and adjustable by a user and capable of retaining the desired position without support from the user. In this regard, the plug 412 may include a cable portion 415 extending between the mounting body 14 and a more rigid plug end portion 417 adapted to be inserted into the port 18. The cable portion 415 is configured to be adjusted to any position and having sufficient internal strength to hold the mounting body 14 and HEU 16 in a standing/upright position (e.g., above an underlying surface, such as a center console.

FIG. 19 shows yet another embodiment with plug 512 being connected to an angularly adjustable arm 515 that is pivotally connected to the plug and is pivotable about a pivot axis 517. The ability to pivot the arm 515 relative to the plug 512 may allow the HEU 16 to be positioned in a desirable location within the vehicle. The angular position of the arm 515 relative to the plug 512 may be lockable via wingnut 519 and bolt, locking detents, or other locking structures known in the art.

Although the various embodiments depicted in the Figures and described herein highlight various features and associated functionalities, it is contemplated that any of the features and functions of one embodiment may be incorporated into another embodiment. For instance, the telescoping engagement portion of the plug depicted in FIG. 7 can be combined with the adjustable arm of FIG. 19.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A physical and electrical support device for use in connecting a handheld electronic unit to a port on a vehicle and for providing structural support to the handheld electronic unit via the port, the port having a port electrical contact and a port wall, the device comprising:
a plug configured to be insertable within the port, the plug being configured to include an adjustable operative diameter to facilitate rigid engagement with the port wall for enabling a desired degree of support of the plug through contact with the port wall, the plug having at least one plug electrical contact disposable in electrical connection with the port electrical contact when the plug is engaged with the port;
a mounting body moveably coupled to the plug and being configured to have a first form factor, the mounting body having a mount electrical contact in electrical communication with the at least one plug electrical contact; and
a handheld electronic unit configured to be engageable with the mounting body, the handheld electronic device including a portion thereof having a second form factor complementary to the first form factor to facilitate engagement between the handheld electronic unit and the mounting body.

2. The device recited in claim 1, wherein the plug includes a telescoping portion configured to facilitate adjustment of the variable operative diameter.

3. The device recited in claim 1, wherein the telescoping portion is selectively transitional between an extended position and a collapsed position, the operative diameter of the telescoping portion decreasing as the telescoping portion transitions from the collapsed position towards the extended position.

4. The device recited in claim 1, wherein the plug includes a frustoconical surface including the variable outer diameter.

5. The device recited in claim 1, wherein the port is a DC power port, and the plug is configured to be insertable into the DC power port to facilitate engagement between the DC power port and the plug.

6. The device recited in claim 1, wherein the plug is configured to be moveable relative to the mounting body within a prescribed range of motion.

7. The device recited in claim 1, wherein the mounting body includes a recess adapted to receive a portion of the plug when the plug is within a portion of the prescribed range of motion.

8. The device recited in claim 1, wherein the mounting body is pivotally connected to the plug.

9. The device recited in claim 1, wherein the first form factor includes a pair of opposed tapered walls.

10. The device recited in claim 1, wherein the handheld electronic unit is configured to be slidably engageable with the mounting body.

11. The device recited in claim 1, wherein handheld electronic unit is a vehicle diagnostic dongle configured to communicate with a vehicle electrical system.

12. The device recited in claim 1, wherein the handheld electronic unit is a power bank configured to supply power to a separate electronic unit.

13. The device recited in claim 1, wherein the plug includes a terminal end opposite the mounting body to define a plug length as the distance between the terminal end and the mounting body, the plug being configured to enable adjustment in the plug length.

14. The device recited in claim 1, wherein the plug and the mounting body are collectively configured to transfer a load applied by the handheld electronic device to the port wall when the plug is inserted in the port.

15. A support device for use in connecting a handheld electronic unit having an electronic unit form factor to a port on a vehicle for providing structural support to the handheld electronic unit via the port, the port having a port electrical contact, the device comprising:
a plug sized and configured to be insertable within the port and engageable with a port wall to facilitate rigid support of the plug through contact with the port wall, the plug having at least one plug electrical contact disposable in electrical connection with the port electrical contact when the plug is engaged with the port; and
a mounting body moveably coupled to the plug and being configured to have a mounting form factor complementary to the electronic unit form factor to facilitate engagement between the mounting device and the handheld electronic unit, the mounting body having a mount electrical contact in electrical communication with the at least one plug electrical contact.

16. The device recited in claim 15, wherein the port is a DC power port, and the plug is configured to be insertable into the DC power port to facilitate engagement between the DC power port and the plug.

17. The device recited in claim 15, wherein the plug is configured to be moveable relative to the mounting body within a prescribed range of motion.

18. The device recited in claim 17, wherein the mounting body includes a recess adapted to receive a portion of the plug when the plug is within a portion of the prescribed range of motion.

19. The device recited in claim 15, wherein the mounting body is pivotally connected to the plug.

20. The device recited in claim 15, wherein the mounting form factor includes a pair of opposed tapered walls.

21. The device recited in claim 15, wherein the mounting body is configured to be slidably engageable with the handheld electronic unit.

22. The device recited in claim 15, wherein the plug includes a terminal end opposite the mounting body to define a plug length as the distance between the terminal end and the mounting body, the plug being configured to enable adjustment in the plug length.

23. The device recited in claim 15, wherein the plug and the mounting body are collectively configured to transfer a load applied by the handheld electronic device to the port wall.
